(19) United States
(12) Patent Application Publication
(10) Pub. No.: US 2010/0057855 A1
(43) Pub. Date: Mar. 4, 2010

(54) TRACKING SUBJECT MATTER IN AN E-MAIL DISCUSSION

(75) Inventors: Al Chakra, Apex, NC (US); Brian Hussey, Dublin (IE); Simon P. O'Doherty, Dublin (IE); David Powell, Meath (IE)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: INTERNATIONAL BUSINESS MACHINES CORPORATION, Armonk, NY (US)

(21) Appl. No.: 12/199,235

(22) Filed: Aug. 27, 2008

(51) Int. Cl. G06F 15/16; G06F 17/30

(52) U.S. Cl. 709/206; 707/3; 707/E17.014

(57) ABSTRACT

Methods, systems, and computer readable media for tracking subject matter of an e-mail discussion are described. A query e-mail is received, wherein the query e-mail includes an initial request and wherein the query e-mail commences the e-mail discussion. At least one marked response e-mail is received, wherein the at least one marked response e-mail includes information responsive to the query e-mail and is marked with an indication that the initial request has been resolved, and wherein the at least one marked response e-mail is appended to the e-mail discussion. At least one visual indicator in the e-mail discussion is provided that distinguishes at least one of the query e-mail and the at least one marked response e-mail when the e-mail discussion is opened at a later time.

### BACKGROUND OF THE INVENTION

Current e-mail systems have the ability to deliver e-mails that are organized in a threaded fashion. Threaded e-mails (“e-mail discussions”) can allow a reader to track a topic of discussion, and in a work setting, can be used, for example, to discuss particular queries or problems within a group of e-mail recipients. The actual content of an e-mail discussion, however, can change over time and encompass multiple threads while the e-mail subject line stays the same. Conventionally, to reflect a change in topics in the e-mail discussion, a new discussion must be created or the subject line must be changed. Another way to keep track of topic changes within the e-mail discussion is to append all e-mails in the e-mail discussion to the latest e-mail, thereby displaying the history of the e-mail discussion.

While these solutions can reflect changes in discussion topic, it can be difficult to determine the context of the initial subject and the status of each participant of the e-mail discussion when the reader receives the e-mail discussion at a later date. For example: the user may have returned from vacation to find a large number of e-mails waiting for them in their inbox. An e-mail discussion may have in excess of fifty e-mails that purport to relate to a subject matter that needs to be addressed (e.g., “Serious flaw in product!”). Reading the last couple of mails in the discussion, the user may find that the discussion is about a different subject matter. Working further back through the thread may reveal that the subject matter changed more than once. As a result, the user may be required to read the thread from the start, in the process wasting time by reviewing irrelevant information and queries that have already been resolved.

Alternatively, if they do not review all of the e-mails within the discussion, the user may not see an e-mail related to the subject matter the user is interested in. This can cause the user to do duplicative work to respond to a query that has already been answered. Only by reading the full e-mail discussion can a user understand the status of the query.

### BRIEF SUMMARY OF THE INVENTION

Methods, systems, and computer readable media for tracking subject matter of an e-mail discussion are described. A query e-mail is received, wherein the query e-mail includes an initial request and wherein the query e-mail commences the e-mail discussion. At least one marked response e-mail is received, wherein the at least one marked response e-mail includes information responsive to the query e-mail and is marked with an indication that the initial request has been resolved, and wherein the at least one marked response e-mail is appended to the e-mail discussion. At least one visual indicator in the e-mail discussion is provided that distinguishes at least one of the query e-mail and the at least one marked response e-mail when the e-mail discussion is opened at a later time.

### BRIEF DESCRIPTION OF SEVERAL VIEWS OF THE DRAWINGS

FIG. 1 illustrates an exemplary embodiment of a system wherein an e-mail discussion wherein subject matter is tracked is provided.

FIG. 2 illustrates an exemplary embodiment of a process for providing an e-mail discussion wherein subject matter is tracked.

FIGS. 3A-E illustrate screenshots from a process for providing an e-mail discussion wherein subject matter is tracked.

### DETAILED DESCRIPTION OF THE INVENTION

Processes, systems, and computer readable media for providing an e-mail discussion wherein subject matter is tracked are described. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

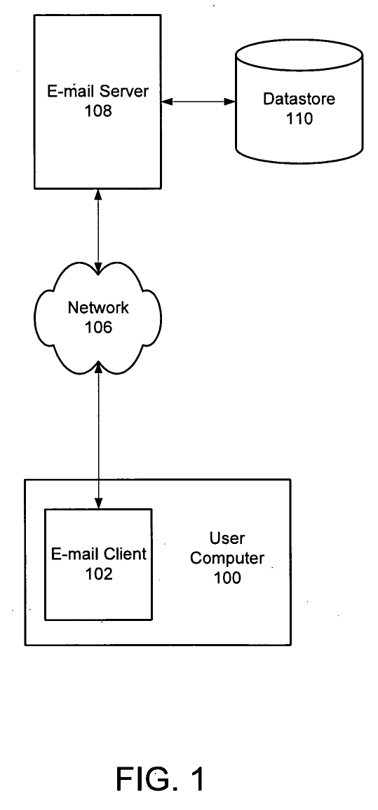

FIG. 1 illustrates an exemplary embodiment of a system for tracking subject matter of an e-mail discussion. The system can include a user computer 100, an e-mail client 102, a network 106, an e-mail server 108, and an e-mail datastore 110. E-mail can be stored on the e-mail datastore 110, and can be transferred to the e-mail client 102 when a request is made by the e-mail client 102. The transfer can take place over the network 106, such as the Internet, or any other type of public or private wired or wireless network. In one exemplary embodiment, at least the user computer 100 and e-mail client 102 may be used in an enterprise environment where the user of the e-mail client, such as a representative of the enterprise, is sent e-mails with questions or queries that require resolution. Many such e-mails may be sent to the e-mail client 102 in an e-mail discussion, where the e-mails in the discussion have the same or different subject matter.

As described below, the system shown in FIG. 1 can be used to track the subject matter of an e-mail discussion. Tracking the subject matter within the e-mail discussion allows a recipient of the e-mail discussion to access a query e-mail and the response e-mails within the discussion, thereby increasing the efficiency of reviewing the e-mail discussion.

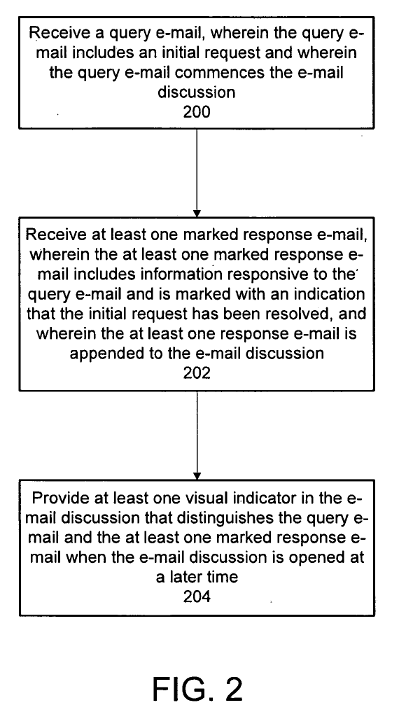

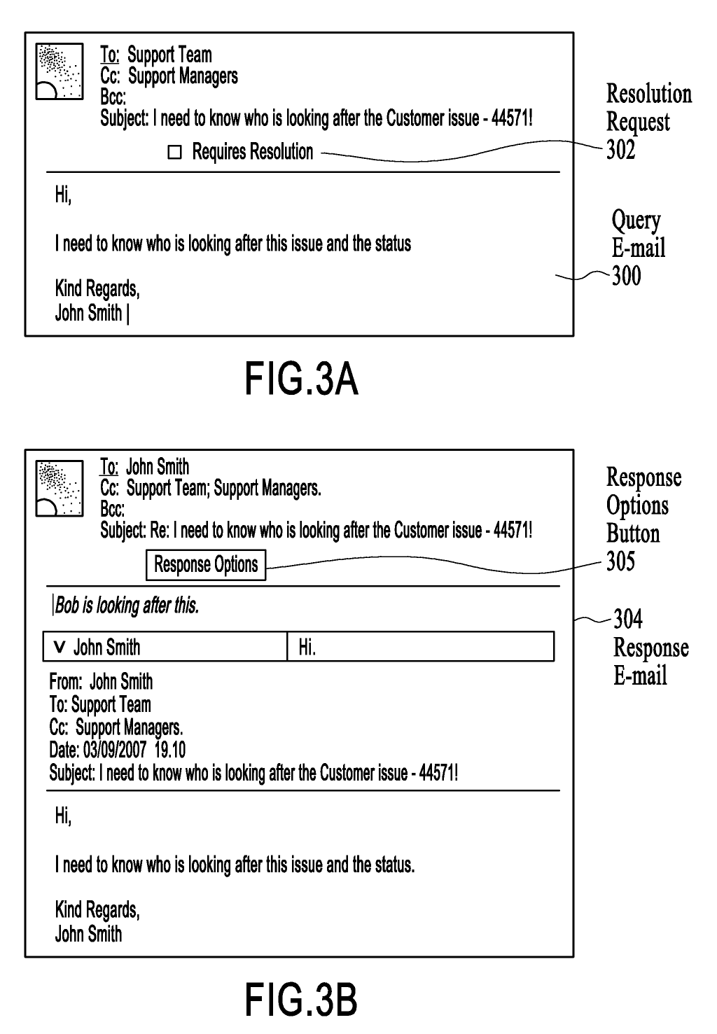

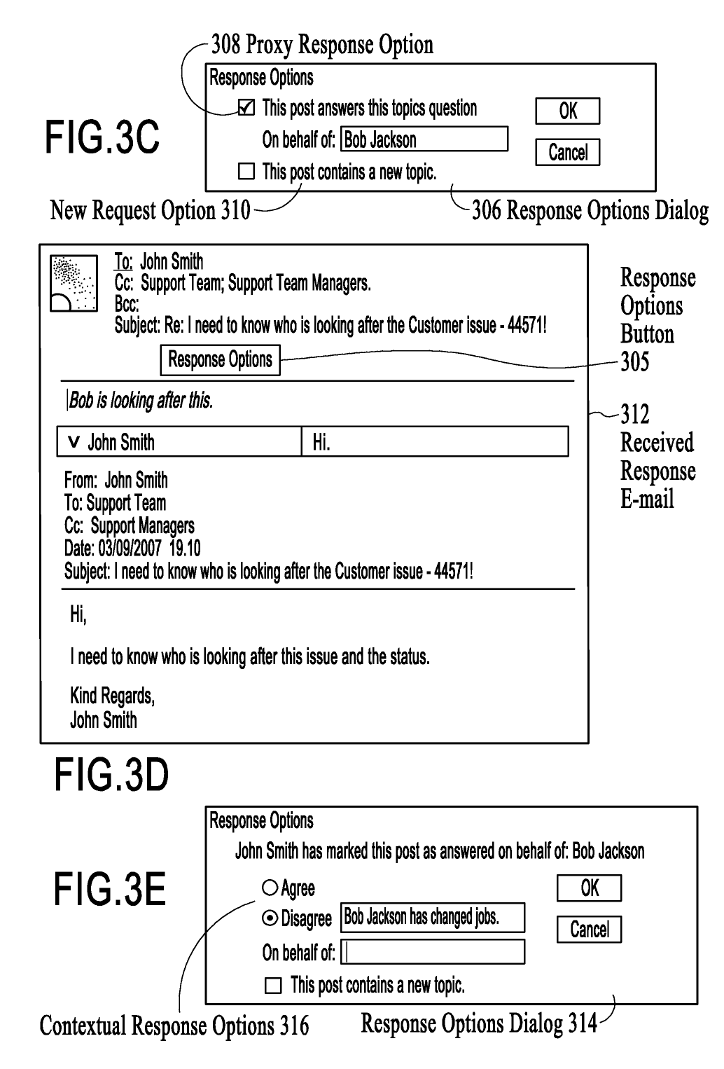

FIG. 2 illustrates an exemplary embodiment of a process for tracking the subject matter of an e-mail discussion. Also, FIGS. 3A-E, which shall be discussed in connection with FIG. 2, illustrate screenshots from the process for tracking the subject matter of the e-mail discussion.

A query e-mail is received, wherein the query e-mail includes an initial request and wherein the query e-mail commences the e-mail discussion (block 200). The query e-mail may take the form of query e-mail 300, which includes an option to request resolution 302. The initial request can include a task or a question, and the query e-mail can request resolution to the initial request. In an exemplary embodiment, an input is received that marks the query e-mail as requiring a resolution. This can be advantageous, for example, to distinguish the query e-mail from other e-mails which may not require resolution.

The query e-mail can be received by the e-mail client 102, for example, and can be the first e-mail in the e-mail discussion thread. The query e-mail can be sent by a query sender, and can be received by one or more query e-mail recipients. In an exemplary embodiment, the query sender can designate one or more stakeholders. The stakeholders can be individuals that the query sender believes has an interest in the resolution of the initial request. Not all query e-mail recipients need to be stakeholders; however, any query e-mail recipient can become a stakeholder if they desire to participate in the resolution of the initial request. Examples of such participation can include, for example, submitting a response e-mail, or by marking an e-mail within the e-mail discussion with an indication. In an exemplary embodiment, the participation can include providing a response feedback related to the at least one response e-mail. This response feedback can be, for example, at least one of agreement or disagreement with the at least one response e-mail.

After the query e-mail is received by the query e-mail recipients, e-mails can be sent that can populate the e-mail discussion (i.e., be added to the thread). At least one response e-mail can be received, wherein the at least one response e-mail includes information responsive to the query e-mail and an indication that the initial request has been resolved, and wherein the at least one response e-mail is appended to the e-mail discussion (block 202). The response e-mail (e.g., response e-mail 304) can be sent by a response sender, and the response sender can elect to mark the response e-mail with an indication that the initial request has been resolved (e.g., when the response sender believes that the response e-mail resolves the initial request). As described below, in an exemplary embodiment, a response options dialog can appear when a query e-mail recipient elects to reply to the query e-mail. The indication that the initial request has been resolved can be created using the response options dialog, for example. The indication that initial request has been resolved can be embedded within the response e-mail, and may or may not be visible to the query e-mail recipients.

In an exemplary embodiment, the indication that the initial request has been resolved can be provided on the behalf of a person other than the response sender. This can be advantageous, for example, when the response sender knows that the initial request is being addressed by another person.

When an e-mail in the e-mail discussion is marked with an indication that the initial request has been resolved, the indication is propagated to every query e-mail recipient (e.g., using e-mail server 108). The indication that the initial request has been resolved can take the form of a flag, a modified header, or any other suitable indication. Though the indications may be applied to any e-mail in the e-mail discussion, in an exemplary embodiment, the indications can be used to indicate e-mails that resolve requests in the e-mail discussion, thereby signifying that no action need be taken on behalf of the requests. This can be advantageous because it can inform all query e-mail recipients that a request has been handled without requiring the input of the query sender, or from all of the stakeholders.

The e-mail discussion can include one or more unmarked e-mails. In some embodiments, an indication that a request has been resolved can be received that marks an unmarked e-mail. This can be done, for example, to signify that the now-marked e-mail provides a resolution to the request that is in question.

In an exemplary embodiment, a response options dialog can be caused to appear, wherein the response options dialog can permit a user to mark the at least one response e-mail, for example, with an indication that the initial request has been resolved. For example, a response options dialog 306 can be caused to appear when a response options button 305 is selected. The response options dialog 306 can include proxy response option 308, which permits a query e-mail recipient to respond to the query e-mail on behalf of another person, and new request option 310, which can permit the query e-mail recipient to post another request (and thereby start a new thread within the e-mail discussion, in some embodiments).

The response options dialog can appear in the e-mail after a user has selected “Reply” in an exemplary embodiment, or can be always present in the e-mail. The response options dialog can be a context sensitive dialog that can appear to each query e-mail recipient. The response options dialog can be sensitive to the current state of the e-mail discussion, meaning that it can provide different options depending on whether or not the initial request has been resolved.

For example, response e-mail 304 can be appended to the e-mail discussion, and received by a second query e-mail recipient, as shown in received response e-mail 312. The received response e-mail can be marked with an indication that it resolves the initial request. If the second query e-mail recipient selects the response options button 305, then a response options dialog 314 can be displayed. Response options dialog 314 differs from the response options dialog 306 in that it also includes contextual response options 316, which can allow the second query e-mail recipient to agree or disagree with the received response e-mail 312. By participating in the e-mail discussion using the contextual response options 316, the second query e-mail recipient can become a stakeholder, and his or her agreement/disagreement can be propagated to the other query e-mail recipients. In an exemplary embodiment, the agreement/disagreement can be presented in the form of an agreement/disagreement flag, in substantially the same fashion as marked e-mails indicating that the initial request has been resolved within the e-mail discussion. In another exemplary embodiment, the agreement/disagreement can be appended to the e-mail discussion in an automatically-generated agreement/disagreement e-mail. This automatically generated agreement/disagreement e-mail can then be marked as described above with an indication that it pertains to the response to the initial request. Also, the second query e-mail recipient can include text with the agreement/disagreement. This text can be associated with an agreement/disagreement flag, or can be placed within the body of an automatically-generated agreement/disagreement e-mail.

At least one visual indicator can be provided that distinguishes at least one of the query e-mail and the at least one marked response e-mail when the e-mail discussion is opened at a later time (block 204). This can improve the efficiency of review when a query e-mail recipient is reviewing the e-mail discussion to see that the query sender's request has been addressed, and can efficiently provide the query e-mail recipient with the status of each stakeholder. Providing the visual indicator in the e-mail discussion can also be advantageous because providing the visual indicator can preclude the need to review large volumes of duplicate or outdated information, for example.

The e-mails marked with an indication can include the response options dialog in an exemplary embodiment. Furthermore, the mail client can sort the e-mail discussion, identify the marked e-mails therein, and provide visual indicators that distinguish the marked e-mails from other e-mails in the e-mail discussion. Any suitable means can be used to present the visual indicators for the marked e-mails (e.g., selectable links to the marked e-mails, a drop-down menu providing access to the marked e-mails, presenting the marked e-mails with an icon indicating that the e-mail has been marked, and/or displaying the subject lines of the marked e-mails using a different text font and/or style).

In an exemplary embodiment, threads containing queries that are unresolved can be distinguished from threads containing queries that have been resolved. For example, an open thread can be identified as one in which no stakeholders have signed off on the resolution of the thread. Conversely, a closed thread can be a thread in which one or more stakeholders have marked a response e-mail with an indication that the request has been resolved. To show the difference to a query e-mail recipient, e-mails that are part of an open thread can be highlighted, or presented using a bold font. By differentiating between open and closed threads, efficiency of review of the e-mail discussion can be improved.

In an exemplary embodiment, the invention is implemented in software, which includes but is not limited to firmware, resident software, microcode, etc. The invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is mainly described in terms of particular systems provided in particular implementations. However, one of ordinary skill in the art will readily recognize that this method and system will operate effectively in other implementations. For example, the systems, devices, and networks usable with the present invention can take a number of different forms. The present invention will also be described in the context of particular methods having certain steps. However, the method and system operate effectively for other methods having different and/or additional steps not inconsistent with the present invention.

A method and system for providing e-mail discussion wherein subject matter is tracked has been described. The present invention has been described in accordance with the embodiments shown, and one of ordinary skill in the art will readily recognize that there could be variations to the embodiments, and any variations would be within the spirit and scope of the present invention. For example, the present invention can be implemented using hardware, software, a computer readable medium containing program instructions, or a combination thereof. Software written according to the present invention is to be either stored in some form of computer-readable medium such as memory or CD-ROM, or is to be transmitted over a network, and is to be executed by a processor. Consequently, a computer-readable medium is intended to include a computer readable signal, which may be, for example, transmitted over a network. Accordingly, many modifications may be made by one of ordinary skill in the art without departing from the scope of the appended claims.

We claim:

1. A method for tracking subject matter of an e-mail discussion, comprising:
receiving a query e-mail, wherein the query e-mail comprises an initial request and wherein the query e-mail commences the e-mail discussion;
receiving at least one marked response e-mail, wherein the at least one marked response e-mail comprises information responsive to the query e-mail and is marked with an indication that the initial request has been resolved, and wherein the at least one marked response e-mail is appended to the e-mail discussion; and
providing at least one visual indicator in the e-mail discussion that distinguishes at least one of the query e-mail and the at least one marked response e-mail when the e-mail discussion is opened at a later time.

2. The method of claim 1 wherein the e-mail discussion further comprises one or more unmarked e-mails, further comprising receiving an indication that the initial request has been resolved that marks an unmarked e-mail.

3. The method of claim 2 wherein the indication that the initial request has been resolved is provided on behalf of another person.

4. The method of claim 1 wherein the e-mail discussion comprises two or more threads, further comprising distinguishing between threads containing queries that are unresolved and threads containing queries that have been resolved.

5. The method of claim 1 further comprising causing a response options dialogue box to appear, wherein the response options dialogue box permits a user to flag the at least one response e-mail.

6. The method of claim 1 further comprising receiving a query response indicating that the initial request has been answered.

7. The method of claim 6 wherein the query e-mail is sent by a query sender, wherein the query response is submitted by a stakeholder, wherein the stakeholder has received stakeholder status from the query sender.

8. The method of claim 1 wherein the query e-mail is received by at least one query recipient, further comprising permitting the at least one query recipient to provide a response feedback related to the at least one response e-mail.

9. The method of claim 8 wherein the response feedback comprises at least one of agreement or disagreement with the at least one response e-mail.

10. A system for providing an e-mail discussion wherein subject matter is tracked, comprising:
memory; and
a processor, wherein the processor is configured to:
receive a query e-mail, wherein the query e-mail comprises an initial request and wherein the query e-mail commences the e-mail discussion;
receive at least one marked response e-mail, wherein the at least one marked response e-mail comprises information responsive to the query e-mail and is marked with an indication that the initial request has been resolved, and wherein the at least one marked response e-mail is appended to the e-mail discussion; and
provide at least one visual indicator in the e-mail discussion that distinguishes at least one of the query e-mail and the at least one marked response e-mail when the e-mail discussion is opened at a later time.

11. The system of claim 10 wherein the e-mail discussion further comprises one or more unmarked e-mails, wherein the processor is further configured to receive an indication that a request has been resolved that marks an unmarked e-mail.

12. The system of claim 11 wherein the indication that the initial request has been resolved is provided on behalf of another person.

13. The system of claim 10 wherein the e-mail discussion comprises two or more threads, wherein the processor is further configured to distinguish between threads containing queries that are unresolved and threads containing queries that have been resolved.

14. The system of claim 10 wherein the processor is further configured to cause a response options dialogue box to appear, wherein the response options dialogue box permits a user to flag the at least one response e-mail.

15. The system of claim 10 wherein the processor is further configured to receive a query response indicating that the initial request has been answered.

16. The system of claim 15 wherein the query e-mail is sent by a query sender, wherein the query response is submitted by a stakeholder, wherein the stakeholder has received stakeholder status from the query sender.

17. The system of claim 10 wherein the query e-mail is received by at least one query recipient, further comprising permitting the at least one query to provide a response feedback related to the at least one response e-mail.

18. The system of claim 17 wherein the response feedback comprises at least one of agreement or disagreement with the at least one response e-mail.

19. An executable software product stored on a computer-readable medium containing program instructions for providing an e-mail discussion wherein subject matter is tracked, the program instructions for:
receiving a query e-mail, wherein the query e-mail comprises an initial request and wherein the query e-mail commences the e-mail discussion;
receiving at least one marked response e-mail, wherein the at least one marked response e-mail comprises information responsive to the query e-mail and is marked with an indication that the initial request has been resolved, and wherein the at least one marked response e-mail is appended to the e-mail discussion; and
providing at least one visual indicator in the e-mail discussion that distinguishes at least one of the query e-mail and the at least one marked response e-mail when the e-mail discussion is opened at a later time.

20. The executable software product of claim 19 wherein the e-mail discussion further comprises one or more unmarked e-mails, further comprising program instructions for receiving an indication that the initial request has been resolved that marks an unmarked e-mail.

21. The executable software product of claim 20 wherein the indication that the initial request has been resolved is provided on behalf of another person.

22. The executable software product of claim 19 wherein the e-mail discussion comprises two or more threads, further comprising program instructions for distinguishing between threads containing queries that are unresolved and threads containing queries that have been resolved.

23. The executable software product of claim 19 further comprising program instructions for causing a response options dialogue box to appear, wherein the response options dialogue box permits a user to flag the at least one response e-mail.

24. The executable software product of claim 19 further comprising program instructions for receiving a query response indicating that the initial request has been answered.

25. The executable software product of claim 24 wherein the query e-mail is sent by a query sender, wherein the query response is submitted by a stakeholder, wherein the stakeholder has received stakeholder status from the query sender.
